(19) United States
(12) Patent Application Publication
(10) Pub. No.: US 2015/0254996 A1
(43) Pub. Date: Sep. 10, 2015

(54) Method and System of the 90 Day Race Formula.

(71) Applicant: Rollan Roberts, II, Whitefish, MT (US)

(72) Inventor: Rollan Roberts, II, Whitefish, MT (US)

(21) Appl. No.: 14/070,554

(22) Filed: Mar. 10, 2014

(51) Int. Cl. G09B 19/00

(52) U.S. Cl. CPC G09B 19/00

(57) ABSTRACT

Many people try to lose weight, get fit, grow their business, get out of debt, excel in the arts, music, sports, or otherwise achieve some measure of accomplishment in an area of life. As statistics prove, relative to the number of people who wish to attain some measure of achievement in these areas, very few ever realize their objective or accomplish what they intend too.

The 90 Day Race Formula is designed to provide a method and system for maximizing the likelihood and potential for attainment of objectives in life for individuals, organizations and companies.

The 90 Day Race Formula is based on an annual plan that follows the four seasons of nature and the four quarters of business in a calendar year.

Following the 90 Day Race Formula allows compounded results and momentum to occur based on doing the activity and behaviors one may otherwise do over an extended period of time, in a condensed period of time, thus allowing a higher likelihood of accomplishing the objective.

### BACKGROUND OF THE INVENTION

Problem Solved:

Many people try to lose weight, get fit, grow their business, get out of debt, excel in the arts, music, sports, or otherwise achieve some measure of accomplishment in an area of life. As statistics prove, relative to the number of people who wish to attain some measure of achievement in these areas, very few ever realize their objective or accomplish what they intend too.

The 90 Day Race Formula is designed to provide a method and system for maximizing the likelihood and potential for attainment of objectives in life.

It has been proven through personal experience and nature itself the cyclical nature of life, of which human beings are a part of. The 90 Day Race Formula is an annual plan that follows the four seasons of nature and the four quarters of business.

Following the 90 Day Race Formula allows compounded results and momentum to occur based on doing the activity and behaviors one may otherwise do over an extended period of time, in a condensed period of time, thus allowing a higher likelihood of accomplishing the objective.

This patent claims the following 90 Day Race formula as a process of making specific, behavioral changes, habit and schedule changes for the purpose of getting a different result in a specific area of life.

### DETAILED DESCRIPTION OF THE INVENTION

The 90 Day Race Formula is a method and system for maximizing the likelihood for the attainment of set objectives.

The Formula contains an annual plan by which one could follow the four seasons of business and nature to improve their ability to accomplish and attain objectives.

The 90 Day Race Annual Formula is as follows:

First Quarter—90 Day Race: Plan—Do—Review—Adjust with all-out Intensity and Focus.

Second Quarter—Post 90 Day Race: Refresh, Regroup, Recharge

Third Quarter—90 Day Race: Plan—Do—Review—Adjust with all-out Intensity and Focus.

Fourth Quarter—Post 90 Day Race: Refresh, Regroup, Recharge

Below is a week-by-week overview of the plan, do, review, adjust 90 Day Race Formula for the accomplishment of objectives:

Week 1
Identify Clear Objective
Determine Daily Habits and Schedule Change
Determine Appropriate Daily Behavior and Activities
Identify the Top 2-3 Critical Behaviors or Activities that are required to

Achieve Objective
Implement Changes Immediately

Week 2
Go Full Week implementing Changes
End of week, review what's working and what's not
Adjust as Needed
Develop a Tangible or Verbal Action to Do or Say when you want to quit during the 90 Day Race
Follow “Plan—Do—Review—Adjust” Formula

Week 3
Increase Intensity of Daily Activities
Identify Schedule Gaps and Fill with Behaviors and Activities that support the Objective
Confirm your Schedule indicates Focus on the Critical Few (top 2-3 behaviors and activities) not the Trivial Many (all the things you could be busy with, but are not the most important to achieving the Objective)
Follow “Plan—Do—Review—Adjust” Formula

Week 4-12
Be at full intensity; all-out behavior
Assess your Attitude and have Provision to Keep you Engaged when you want to quit the 90 Day Race
No Schedule Gaps
No Distractions from Objective
Confirm your Schedule indicates Focus on the Critical Few (top 2-3 behaviors and activities) not the Trivial Many (all the things you could be busy with, but are not the most important to achieving the Objective)
Follow “Plan—Do—Review—Adjust” Formula

In the Annual 90 Day Race Formula, there is a Post 90 Day Race Formula, which is as follows:

Refresh—Week 1

1. Refresh Mentally. Take a week vacation or placing your focus on something entirely different. It is a time to focus on your health and well-being.

2. Refresh Physically. Eat right. Exercise. Drink lots of water. Get lots of sleep. Get your mind, spirit and body in a good place.

That's what Refreshing looks like. One still take calls, answer emails, and stay lightly connected, but only if it requires an immediate response.

Regroup—Week 2

1. Assess your 90-Day Race.

2. Document in a journal what all you did during your 90 Day Race. Document your experiences, thoughts, feelings, and the ups and downs.

3. Assess what the reinvented you and your Objective looks like. What areas do you still want to hone? What adjustments and tweaks do you want to make?

4. Think back on what you accomplished and start planning what the best use of your time and energy is over the next ten weeks to support and tighten up the results you created during the 90-Day Race.

Recharge—Weeks 3-12

1. Recharge Mentally. This is the time for you to grow, read, study, and learn. Read stories of people who have done what you're trying to do. Absorb industry periodicals and training. Take your personal knowledge, skill, and training to the next level.

2. Recharge Physically. Rebuild your physical strength.

3. Recharge Emotionally. Prepare mentally and emotionally for the next 90 Day Race so you have the physical capacity to make it happen.

The Version of The Invention Discussed Here Includes:

The 90 Day Race Annual Formula includes the annual interval series of 90 Day Races following the prescribed formula followed by the specific months of rest and rejuvenation (referred to as the Post 90 Day Race) and following the calendar year.

Below is the annual outline of the 90 Day Race Formula by business quarter followed by the specific, unique formula to be used during both the 90 Day Race and Post 90 Day Race.

First Quarter—90 Day Race: Plan—Do—Review—Adjust with all-out Intensity and Focus.

Second Quarter—Post 90 Day Race: Refresh, Regroup, Recharge

Third Quarter—90 Day Race: Plan—Do—Review—Adjust with all-out Intensity and Focus.

Fourth Quarter—Post 90 Day Race: Refresh, Regroup, Recharge

90 Day Race

Week 1
Identify Clear Objective
Determine Daily Habits and Schedule Change
Determine Appropriate Daily Behavior and Activities
Identify the Top 2-3 Critical Behaviors or Activities that are required to

Achieve Objective
Implement Changes Immediately

Week 2
Go Full Week implementing Changes
End of week, review what's working and what's not
Adjust as Needed
Develop a Tangible or Verbal Action to Do or Say when you want to quit during the 90 Day Race
Follow “Plan—Do—Review—Adjust” Formula

Week 3
Increase Intensity of Daily Activities
Identify Schedule Gaps and Fill with Behaviors and Activities that support the Objective
Confirm your Schedule indicates Focus on the Critical Few (top 2-3 behaviors and activities) not the Trivial Many (all the things you could be busy with, but are not the most important to achieving the Objective)
Follow “Plan—Do—Review—Adjust” Formula

Week 4-12
Be at full intensity; all-out behavior
Assess your Attitude and have Provision to Keep you Engaged when you want to quit the 90 Day Race
No Schedule Gaps
No Distractions from Objective
Confirm your Schedule indicates Focus on the Critical Few (top 2-3 behaviors and activities) not the Trivial Many (all the things you could be busy with, but are not the most important to achieving the Objective)
Follow “Plan—Do—Review—Adjust” Formula

Post 90-Day Race

Refresh—Week 1

1. Refresh Mentally. Take a week vacation or placing your focus on something entirely different. It is a time to focus on your health and well-being.

2. Refresh Physically. Eat right. Exercise. Drink lots of water. Get lots of sleep. Get your mind, spirit and body in a good place.

That's what Refreshing looks like. One still take calls, answer emails, and stay lightly connected, but only if it requires an immediate response.

Regroup—Week 2

1. Assess your 90-Day Race.

2. Document in a journal what all you did during your 90 Day Race. Document your experiences, thoughts, feelings, and the ups and downs.

3. Assess what the reinvented you and your Objective looks like. What areas do you still want to hone? What adjustments and tweaks do you want to make?

4. Think back on what you accomplished and start planning what the best use of your time and energy is over the next ten weeks to support and tighten up the results you created during the 90-Day Race.

Recharge—Weeks 3-12

1. Recharge Mentally. This is the time for you to grow, read, study, and learn. Read stories of people who have done what you're trying to do. Absorb industry periodicals and training. Take your personal knowledge, skill, and training to the next level.

2. Recharge Physically. Rebuild your physical strength.

3. Recharge Emotionally. Prepare mentally and emotionally for the next 90 Day Race so you have the physical capacity to make it happen.

Relationship Between The Components:

1. Relationship between the 90 Day Race and Post 90 Day Race.
The relationship between the 90 Day Race and Post 90 Day Race is explicitly tied to the fact that one is unable to safely go significantly beyond a 90 day period of time at the level of intensity required in the 90 Day Race.
The Post 90 Day Race is critical to repairing the mind and body and preparing both for another period of intense focus on an objective.

2. Relationship between weeks in the 90 Day Race.
The relationship among weeks 1-12 in the 90 Day Race build one upon the other. It is imperative that one follows the formula for the respective week in order to realize the best possible results from the 90 Day Race.

3. Relationship between weeks in the Post 90 Day Race.
The relationship among weeks 1-12 in the Post 90 Day Race build one upon the other. It is imperative that one follows the formula for the respective week in order to realize the best possible results from the Post 90 Day Race and to adequately prepare for the next 90 Day Race to build upon the results in previous 90 Day Races.

How The Methodology/90 Day Race Annual Formula Works:

The 90 Day Race Annual Formula works as follows:

First Quarter—90 Day Race: Plan—Do—Review—Adjust with all-out Intensity and Focus.

Second Quarter—Post 90 Day Race: Refresh, Regroup, Recharge

Third Quarter—90 Day Race: Plan—Do—Review—Adjust with all-out Intensity and Focus.

Fourth Quarter—Post 90 Day Race: Refresh, Regroup, Recharge

Below is a week-by-week overview of the plan, do, review, adjust 90 Day Race Formula for the accomplishment of objectives:

Week 1
Identify Clear Objective
Determine Daily Habits and Schedule Change
Determine Appropriate Daily Behavior and Activities
Identify the Top 2-3 Critical Behaviors or Activities that are required to Achieve Objective
Implement Changes Immediately

Week 2
Go Full Week implementing Changes
End of week, review what's working and what's not
Adjust as Needed
Develop a Tangible or Verbal Action to Do or Say when you want to quit during the 90 Day Race
Follow “Plan—Do—Review—Adjust” Formula

Week 3
Increase Intensity of Daily Activities
Identify Schedule Gaps and Fill with Behaviors and Activities that support the Objective
Confirm your Schedule indicates Focus on the Critical Few (top 2-3 behaviors and activities) not the Trivial Many (all the things you could be busy with, but are not the most important to achieving the Objective)
Follow “Plan—Do—Review—Adjust” Formula

Week 4 -12
Be at full intensity; all-out behavior
Assess your Attitude and have Provision to Keep you Engaged when you want to quit the 90 Day Race
No Schedule Gaps
No Distractions from Objective
Confirm your Schedule indicates Focus on the Critical Few (top 2-3 behaviors and activities) not the Trivial Many (all the things you could be busy with, but are not the most important to achieving the Objective)
Follow “Plan—Do—Review—Adjust” Formula

In the Annual 90 Day Race Formula, there is a Post 90 Day Race Formula, which is as follows:

Refresh—Week 1

1. Refresh Mentally. Take a week vacation or placing your focus on something entirely different. It is a time to focus on your health and well-being.

2. Refresh Physically. Eat right. Exercise. Drink lots of water. Get lots of sleep. Get your mind, spirit and body in a good place.

That's what Refreshing looks like. One still take calls, answer emails, and stay lightly connected, but only if it requires an immediate response.

Regroup—Week 2

1. Assess your 90-Day Race.

2. Document in a journal what all you did during your 90 Day Race. Document your experiences, thoughts, feelings, and the ups and downs.

3. Assess what the reinvented you and your Objective looks like. What areas do you still want to hone? What adjustments and tweaks do you want to make?

4. Think back on what you accomplished and start planning what the best use of your time and energy is over the next ten weeks to support and tighten up the results you created during the 90-Day Race.

Recharge—Weeks 3-12

1. Recharge Mentally. This is the time for you to grow, read, study, and learn. Read stories of people who have done what you're trying to do. Absorb industry periodicals and training. Take your personal knowledge, skill, and training to the next level.

2. Recharge Physically. Rebuild your physical strength.

3. Recharge Emotionally. Prepare mentally and emotionally for the next 90 Day Race so you have the physical capacity to make it happen.

How To Use The Invention:

The 90 Day Race Invention is designed to be used on an annual basis until one achieves the target objective. The invention is designed to be used in 90 day increments closely paralleled with the seasons of nature and on the calendar year as outlined by the four quarter in business.

The invention is designed for individuals or companies to do a 90 Day Race followed by 90 days of assessment and organization followed by a 90 Day Race followed by another 90 days of assessment and organization. This is a sustainable pattern by which objectives have a great likelihood of accomplishment.

1. This patent claims the following 90 Day Race formula as a process of making specific, behavioral changes, habit and schedule changes for the purpose of getting a different result in a specific area of life. The claim is limited to the method and system of the 90 Day Race Formula.
We claim the specific behaviors recommended for each week for twelve weeks contained in the 90 day race formula (including post-race): Those specific behaviors are as follows:
Week 1
Identify Clear Objective
Determine Daily Habits and Schedule Change
Determine Appropriate Daily Behavior and Activities
Identify the Top 2-3 Critical Behaviors or Activities that are required to Achieve Objective
Implement Changes Immediately
Week 2
Go Full Week implementing Changes
End of week, review what's working and what's not
Adjust as Needed
Develop a Tangible or Verbal Action to Do or Say when you want to quit during the 90 Day Race
Follow “Plan—Do—Review—Adjust” Formula
Week 3
Increase Intensity of Daily Activities
Identify Schedule Gaps and Fill with Behaviors and Activities that support the Objective
Confirm your Schedule indicates Focus on the Critical Few (top 2-3 behaviors and activities) not the Trivial Many (all the things you could be busy with, but are not the most important to achieving the Objective)
Follow “Plan—Do—Review—Adjust” Formula
Week 4-12
Be at full intensity; all-out behavior
Assess your Attitude and have Provision to Keep you Engaged when you want to quit the 90 Day Race
No Schedule Gaps
No Distractions from Objective
Confirm your Schedule indicates Focus on the Critical Few (top 2-3 behaviors and activities) not the Trivial Many (all the things you could be busy with, but are not the most important to achieving the Objective)
Follow “Plan—Do—Review—Adjust” Formula
In the Annual 90 Day Race Formula, there is a Post 90 Day Race Formula, in which the following specific behaviors are claimed:
Refresh—Week 1
1. Refresh Mentally. Take a week vacation or placing your focus on something entirely different. It is a time to focus on your health and well-being.
2. Refresh Physically. Eat right. Exercise. Drink lots of water. Get lots of sleep. Get your mind, spirit and body in a good place.
That's what Refreshing looks like. One still take calls, answer emails, and stay lightly connected, but only if it requires an immediate response.
Regroup—Week 2
1. Assess your 90-Day Race.
2. Document in a journal what all you did during your 90 Day Race. Document your experiences, thoughts, feelings, and the ups and downs.
3. Assess what the reinvented you and your Objective looks like. What areas do you still want to hone? What adjustments and tweaks do you want to make?
4. Think back on what you accomplished and start planning what the best use of your time and energy is over the next ten weeks to support and tighten up the results you created during the 90-Day Race.
Recharge—Weeks 3-12
1. Recharge Mentally. This is the time for you to grow, read, study, and learn. Read stories of people who have done what you're trying to do. Absorb industry periodicals and training. Take your personal knowledge, skill, and training to the next level.
2. Recharge Physically. Rebuild your physical strength.
3. Recharge Emotionally. Prepare mentally and emotionally for the next 90 Day Race so you have the physical capacity to make it happen.
